(19) United States
(12) Patent Application Publication
(10) Pub. No.: US 2018/0043518 A1
(43) Pub. Date: Feb. 15, 2018

(54) POWER TOOL

(71) Applicant: CHERVON (HK) LIMITED, Wanchai (HK)

(72) Inventors: Masatoshi Fukinuki, Nanjing (CN); Jingdong Hao, Nanjing (CN)

(21) Appl. No.: 15/664,880

(22) Filed: Jul. 31, 2017

(30) Foreign Application Priority Data
Aug. 10, 2016 (CN) 201610648796.0

(51) Int. Cl. B25C 1/00; B25C 1/06

(52) U.S. Cl. CPC B25C 1/008; B25C 1/06

(57) ABSTRACT

A power tool for impacting fasteners includes a housing, a striking pin for impacting fasteners, a driving device for driving the striking pin to perform an action of impacting fasteners, a first driving source for providing power to the driving device, a locking element for locking the striking pin, and a second driving source for driving the locking element to lock and/or release the striking pin, which is independent of the first driving source.

### RELATED APPLICATION INFORMATION

This application claims the benefit under 35 U.S.C. §119(a) of Chinese Patent Application No. CN 2016106487960, filed on Aug. 10, 2016, the disclosure of which is incorporated herein by reference in its entirety.

### FIELD OF THE DISCLOSURE

The present disclosure relates generally to power tools and, more particularly, to a power tool for impacting fasteners.

### BACKGROUND OF THE DISCLOSURE

Nailers are a kind of power tool, which can also be called nail guns. The nailer can generate an impacting force and impact nails through a striking pin.

The currently known nailer has only one motor. The motor stores energy for a driving device. The striking pin is fixed by a fixing device. The driving device and the fixing device are connected by a linkage device, so it realizes the linkage of the driving device and the fixing device. When the driving device moves to a predetermined position or the stored energy reaches an extent, the striking pin is released. This mechanical linkage structure is complex and has low reliability.

The statements in this section merely provide background information related to the present disclosure and may not constitute prior art.

### SUMMARY

In one aspect of the disclosure, a power tool for impacting fasteners includes a housing, a striking pin for impacting fasteners, a driving device for driving the striking pin to perform an action of impacting fasteners, a first driving source for providing power to the driving device, a locking element for locking the striking pin, and a second driving source for driving the locking element to lock and/or release the striking pin, which is independent of the first driving source.

Further, the driving device may include a first cylinder being formed with a first chamber for containing air, and a first piston slidably disposed within the first cylinder for fixing the striking pin and driving the striking pin to move.

Further, the driving device may include a first cylinder being formed with a first chamber for containing air, a second cylinder being formed with a second chamber for containing air, the second chamber is communicated with the first chamber, a first piston slidably disposed within the first cylinder for fixing the striking pin and driving the striking pin to move, and a second piston slidably disposed within the second cylinder, which can be driven by the first driving source to do a reciprocating motion.

Further, the locking element may have a first position and a second position, when in the first position, the locking element engages with the striking pin so as to lock the striking pin, when in the second position, the locking element disengages with the striking pin so as to release the striking pin.

Further, the locking element may engage with the striking pin so as to lock the striking pin and the second driving source can drive the locking pin to release the striking pin.

Further, the power tool may include a controller for controlling the second driving source to drive the locking pin so as to release the striking pin, which is electrically connected with the second driving source.

Further, the power tool may include a battery pack where a controller is electrically connected with the second driving source and the battery pack.

Further, the power tool may include a biasing element being capable of biasing the locking element to lock the striking pin.

Further, the power tool may include a battery pack which provides electricity to the first driving source and the second driving source.

Further, the power tool may include a magazine for storing the fasteners.

The device that is the subject of the present disclosure has advantages. By way of example only, when the locking element is driven by the independent second driving source and the second driving source is electronic controlled to realize the release of the locking element, the structure is simple and reliable.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

FIG. 1 is a schematic view of an exemplary power tool.

FIG. 2 is an exploded view of the power tool in FIG. 1.

FIG. 3 is a schematic view of a locking element of the power tool in FIG. 2 which is in a first position.

FIG. 4 is a schematic view of a first piston, a second piston, a first cylinder and a second cylinder in FIG. 3.

FIG. 5 is a sectional view of the structure in FIG. 3.

FIG. 6 is a schematic view of the locking element of the power tool in FIG. 2 which is in a second position.

FIG. 7 is a sectional view of the structure in FIG. 6.

FIG. 8 is a schematic view of another embodiment of a power tool.

FIG. 9 is an exploded view of the power tool in FIG. 8.

FIG. 10 is a schematic view of a locking element of the power tool in FIG. 9 which is in a first position.

FIG. 11 is a sectional view of the locking element in FIG. 9 which is in the first position.

FIG. 12 is a sectional view of the locking element in FIG. 9 which is in a second position.

FIG. 13 is a partial enlarged view of FIG. 11.

FIG. 14 is a partial enlarged view of FIG. 12.

The drawings described herein are for illustrative purposes only of selected embodiments and not all possible implementations, and are not intended to limit the scope of the present disclosure. Corresponding reference numerals indicate corresponding parts throughout the several views of the drawings.

### DETAILED DESCRIPTION

The following description of the preferred embodiments is merely exemplary in nature and is in no way intended to limit the invention hereinafter claimed, its application, or uses.

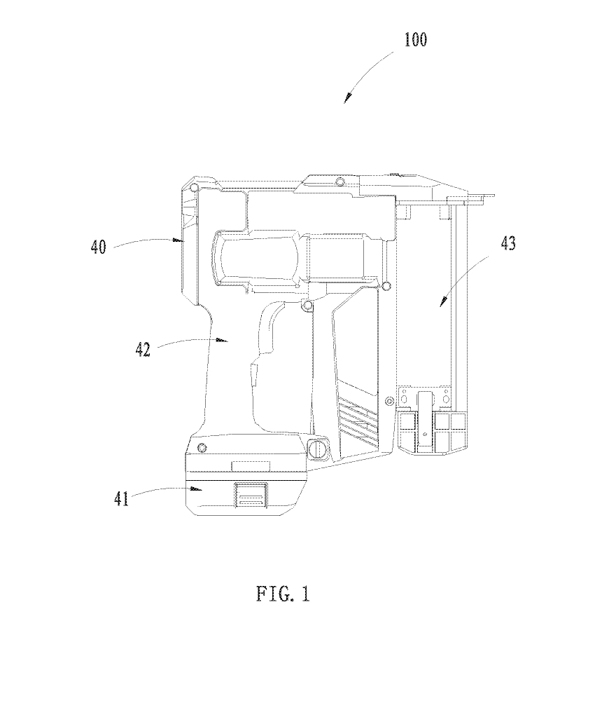

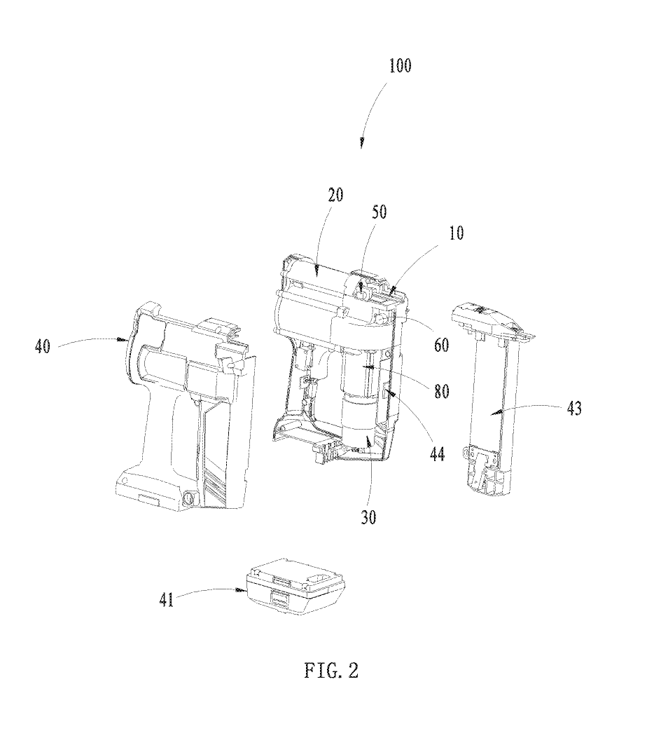

Referring to FIGS. 1-2, a power tool 100 is a nailer which may be called a nail gun. The power tool 100 is capable of generating an impact force so as to impact or eject a nail into a workpiece.

The power tool 100 includes a striking pin 10, a driving device 20, a first driving source 30, a housing 40, a locking element 50, a second driving source 60, a battery pack 41 and a magazine 43.

The striking pin 10 is used to impact fasteners, for example nails. The driving device 20 is used to drive the striking pin 10 to perform the action of impacting the fasteners. The first driving source 30 is used to provide power to the driving device 20. Specifically, the first driving source 30 is a motor. The battery pack 41 provides electricity to the first driving source 30. The power tool 100 can also be called an electric power tool. The housing 40 is configured to mount the first driving source 30. The battery pack 41 is detachably connected with the housing 40. The power tool 100 includes a handle 42 for a user to grip which is formed by the housing 40. The battery pack 41 is connected with one end of the handle 42. The power tool 100 can also be called a hand-held power tool.

The locking element 50 is used to lock the striking pin 10, which has a first position and a second position. In the first position, the locking element 50 locks the striking pin 10, and the driving device 20 cannot drive the striking pin 10 to move. In the second position, the locking element 50 releases the striking pin 10, and the striking pin 10 can move.

The second driving source 60 is independent of the first driving source 30, which means that the second driving source 60 is not the same as the first driving source 30, or the first driving source 30 acts as an independent power source and the second driving source 60 acts as another independent power source. The second driving source 60 is used to drive the locking element 50 to release the striking pin 10. Specifically, the second driving source 60 is a solenoid or an electromagnet. The battery pack 41 provides electricity to the second driving source 60. The power tool 100 further includes a controller 44. The controller 44 is used to control the second driving source 60, so that the second driving source 60 can drive the locking element 50 to release the striking pin 10. The controller 44 is electrically connected with the second driving source 60 and the battery pack 41. In another embodiment, the second driving source can be used to drive the locking element to lock the striking pin. In a further embodiment, the second driving source can drive the locking element to lock the striking pin and also can drive the locking element to release the striking pin.

The magazine 43 is used to store a plurality of fasteners.

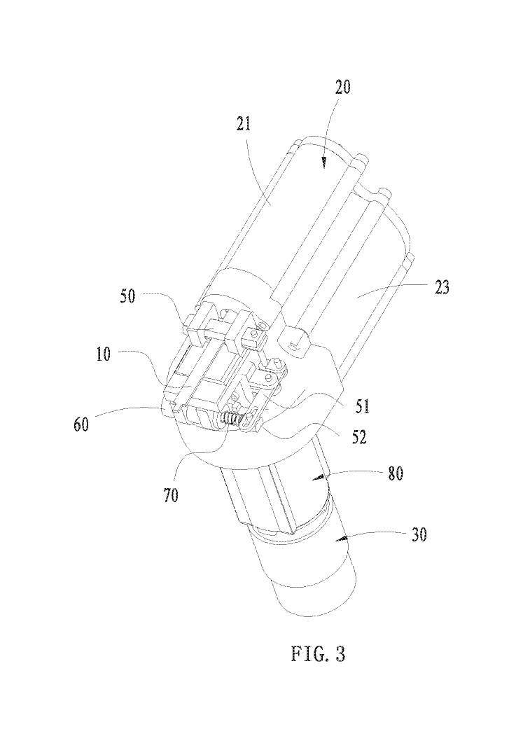

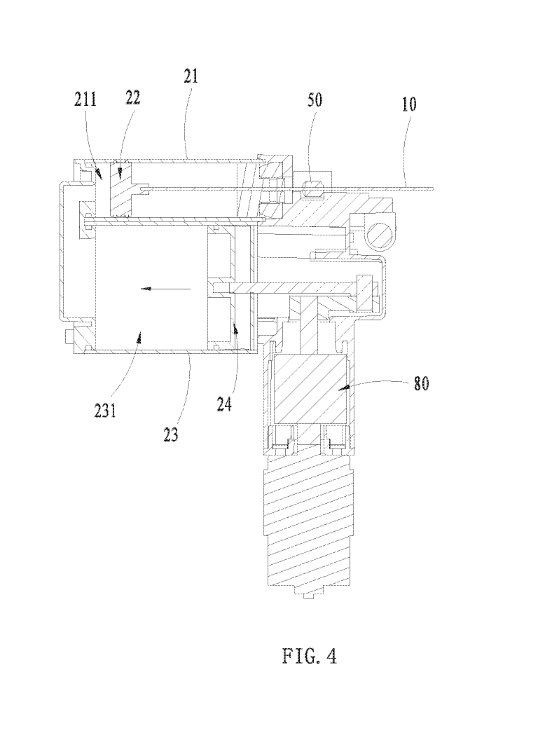

Referring to FIGS. 3-4, a biasing element 70 is used to bias the locking element 50, so that the locking element 50 can lock the striking pin 10. The biasing element 70 may be a leaf spring, a spring or rubber with elasticity, or the like. Preferably, the biasing element 70 is a spring.

The driving device 20 includes a first cylinder 21 and a first piston 22. The first cylinder 21 is formed with a first chamber 211 for containing air. The first piston 22 is slidably disposed within the first cylinder 21. The striking pin 10 is fixedly connected with the first piston 22 and driven by the first piston 22 to move. Each time the first piston 22 drives the striking pin 10 to do an up and down movement, a nail is ejected.

The driving device 20 further includes a second cylinder 23 and a second piston 24. The second cylinder 23 is formed with a second chamber 231 for containing air. The second chamber 231 is communicated with the first chamber 211. The second piston 24 is slidably disposed within the second cylinder 23 and driven by the first driving source 30 to do a reciprocating motion. The first cylinder 21 has an inner diameter which is less than the inner diameter of the second cylinder 23. The first piston 22 has a direction of motion which is substantially parallel to the direction of motion of the second piston 24. The direction of motion of the second piston 24 is substantially parallel to the direction of motion of the striking pin 10.

The power tool 100 further includes a transmission mechanism 80. The second piston 24 is driven by the first driving source 30 to do the reciprocating motion through the transmission mechanism 80.

The first driving source 30 drives the second piston 24 to move is a direction depicted by an arrow in FIG. 4, and the locking element 50 is in the first position to lock the striking pin 10. The air between the first piston 22 and the second piston 24 is compressed. Or it can be said that the air in the first piston 22 and the second piston 24 is compressed. When the second piston 24 moves to the leftmost position, the air in the first piston 22 and the second piston 24 is compressed to a maximum. At this moment, the second driving source 60 drives the locking element 50 to move to the second position so as to release the striking pin 10. The compressed air expands to push the first piston 22 and the striking pin 10 to move so that the striking pin 10 realizes the action of impacting the fastener once.

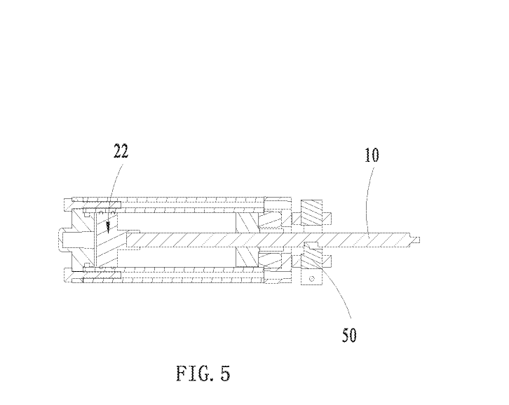

Referring to FIGS. 3 and 5, the locking element 50 is in the first position and engaged with the striking pin 10 so as to realize the locking of the striking pin 10. The striking pin 10 is formed with a gap. The locking element 50 is at least partially extended into the gap to stop the striking pin 10 from moving.

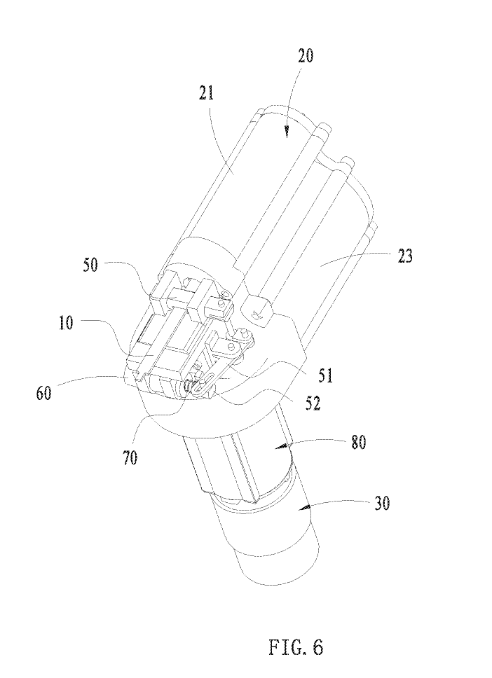

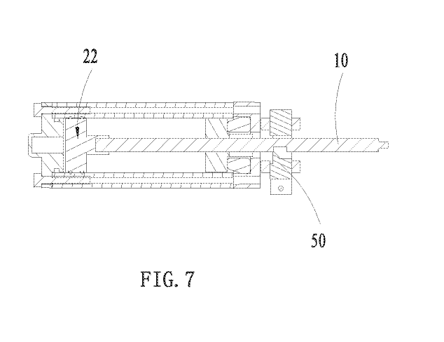

Referring to FIGS. 6-7, the locking element 50 is in the second position and disengaged with the striking pin 10 so as to release the locking of the striking pin 10 whereupon the striking pin 10 is moved and generates the impact force under the action of the compressed air.

The second driving source 60 drives the locking element 50 to move from the first position to the second position. Specifically, the locking element 50 has a direction of motion which is substantially perpendicular to the direction of motion of the striking pin 10. The first driving source 30 is a motor. The direction of motion of the locking element 50 is substantially perpendicular to a rotating axis of the first driving source 30.

The power tool 100 further includes a connecting element 51 and a moving element 52. The moving element 52 is driven by the second driving source 60 to move so as to press the spring. Specifically, the second driving source 60 drives the moving element 52 to move towards the second driving source 60. The moving element 52 drives the connecting element 51 to rotate. The moving element 52 and the locking element 50 are connected with two ends of the connecting element 51 respectively. The rotation of the connecting element 51 drives the locking element 50 to move.

When the second driving source 60 stops driving the moving element 52 to move towards the second driving source 60, or when the second driving source 60 drives the moving element 52 to move towards a direction that is far from the second driving source 60, the biasing element 70 biases the moving element 52 to drive the connecting element 51 to rotate, and finally drive the locking element 50 to move from the second position to the first position. So, it realizes that the locking element 50 engages with the striking pin 10 so as to lock the striking pin 10.

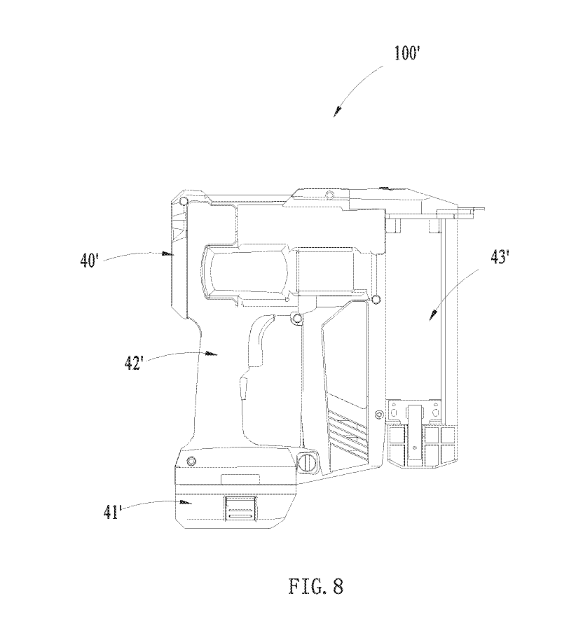

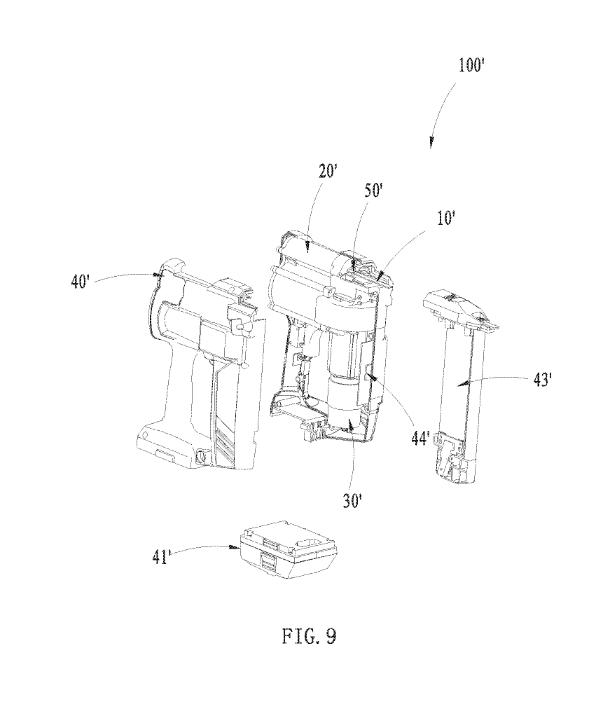

Referring to FIGS. 8-9, a power tool 100′ includes a striking pin 10′, a driving device 20′, a first driving source 30′, a housing 40′, a battery pack 41′, a handle 42′, a magazine 43′ and a controller 44′. The striking pin 10′, the driving device 20′, the first driving source 30′, the housing 40′, the battery pack 41′, the handle 42′, the magazine 43′ and the controller 44′ have the same structure as the corresponding parts in FIGS. 1-2.

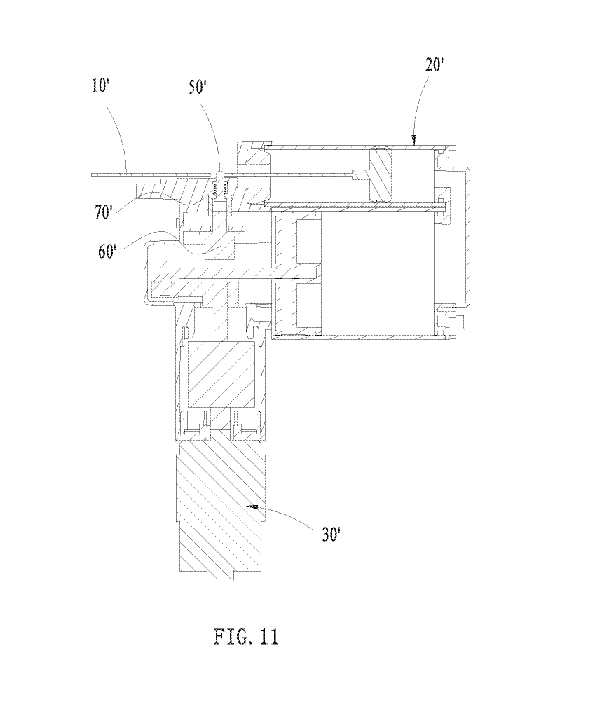

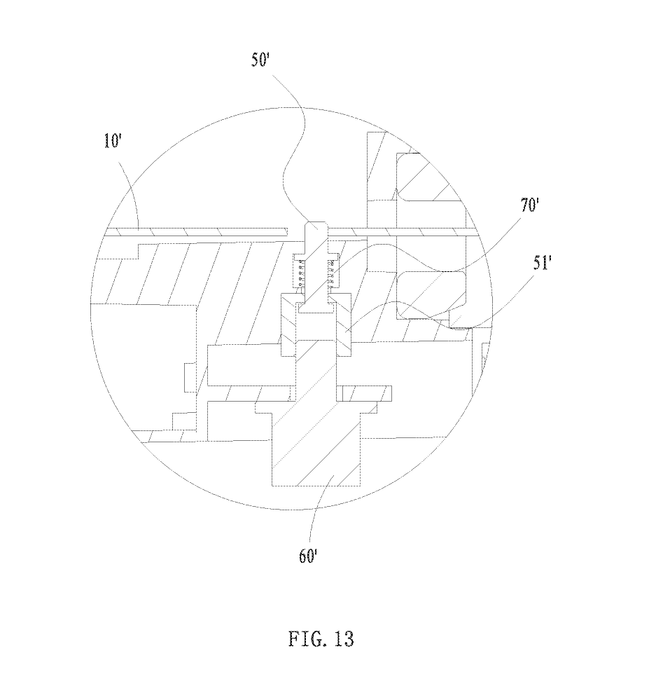

Referring to FIGS. 9-12, the power tool 100′ further includes a locking element 50′ and a second driving source 60′. The locking element 50′ has a first position and a second position. Referring to FIGS. 11 and 13, the locking element 50′ is in the first position and engages with the striking pin 10′ so as to realize the locking of the striking pin 10′. The power tool 100′ further includes a biasing element 70′. The biasing element 70′ biases the locking element 50′ to make the locking element 50′ lock the striking pin 10′. Preferably, the biasing element 70′ is a spring.

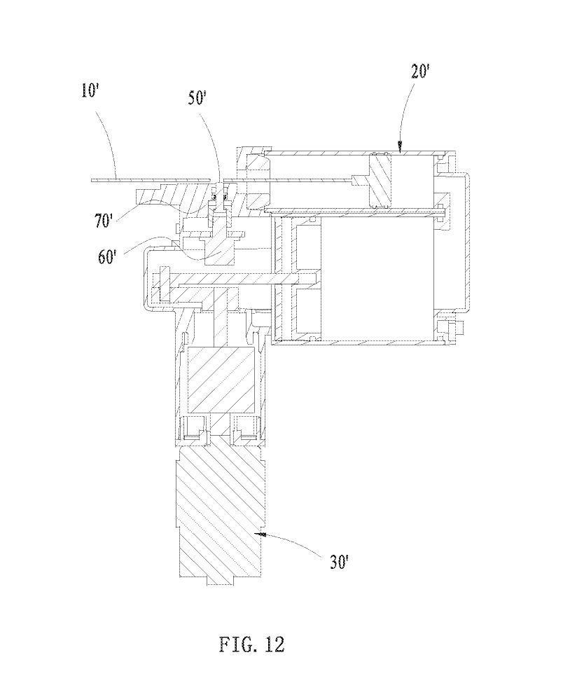

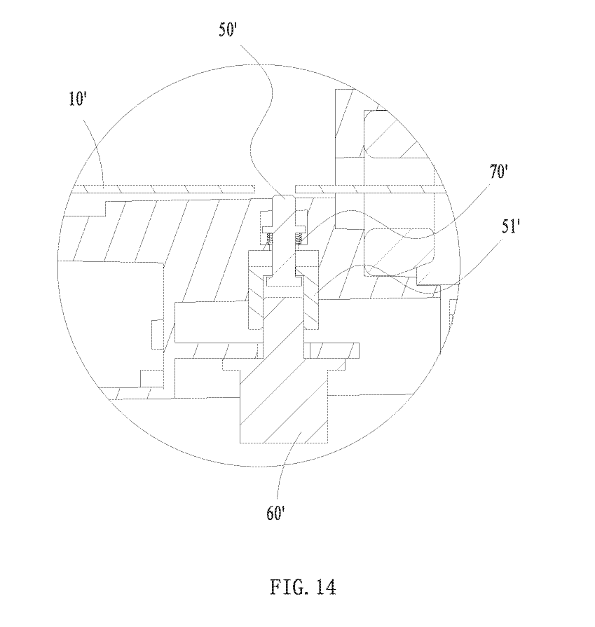

Referring to FIGS. 12 and 14, the locking element 50′ is in the second position and disengages with the striking pin 10′ so as to release the locking of the striking pin 10′.

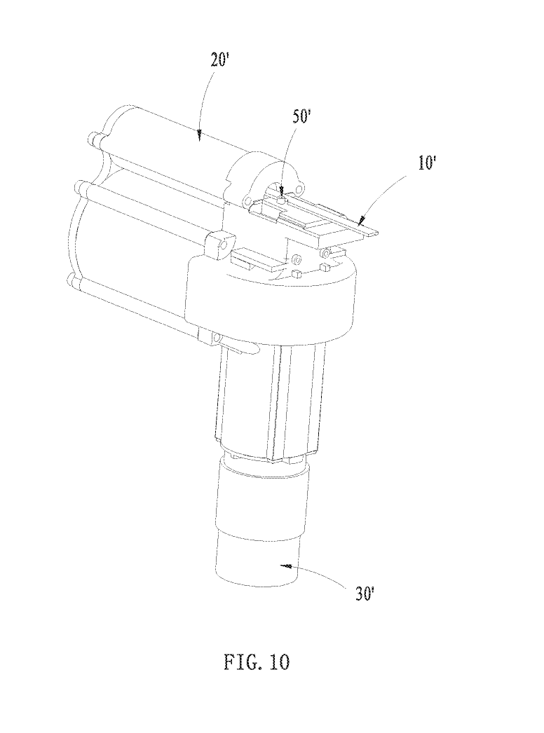

Referring to FIGS. 10-14, the second driving source 60′ is a motor. The controller 44′ controls the second driving source 60′ to drive a connecting element 51′ to slide. The connecting element 51′ is driven by the motor to slide along a rotating axis of the motor. So, the connecting element 51′ drives the locking element 50′ to move from the first position to the second position so as to release the striking pin 10′, which makes the striking pin 10′ generate an impacting force. After the striking pin 10′ is released or when it is needed to lock the striking pin 10′ again, the controller 44′ controls the second driving source 60′ to cancel the driving force acting on the connecting element 51′ or to drive the connecting element 51′ to move so as to make the locking element 50′ move from the second position to the first position under the action of the biasing element 70′. The locking element 50′ finishes engaging with the striking pin 10′ again under the action of the biasing element 70′ so as to realize the locking of the striking pin 10′. The locking element 50′ slides along a sliding direction which is substantially perpendicular to the direction of motion of the striking pin 10′.

The above illustrates and describes basic principles, main features and advantages of the present invention. Those skilled in the art should appreciate that the above embodiments do not limit the invention hereinafter claimed in any form. Rather, technical solutions obtained by equivalent substitution or equivalent variations are all intended to fall within the scope of the claimed invention.

What is claimed is:

1. A power tool for impacting fasteners, comprising:
a striking pin for impacting fasteners;
a driving device for driving the striking pin to perform an action of impacting fasteners;
a first driving source for providing power to the driving device;
a locking element for locking the striking pin; and
a second driving source for driving the locking element to lock and/or release the striking pin;
wherein the second driving source is independent of the first driving source.

2. The power tool of claim 1, wherein the driving device comprises a first cylinder being formed with a first chamber for containing air and a first piston slidably disposed within the first cylinder for fixing the striking pin and driving the striking pin to move.

3. The power tool of claim 1, wherein the driving device comprises a first cylinder being formed with a first chamber for containing air, a second cylinder being formed with a second chamber for containing air wherein the second chamber is communicated with the first chamber, a first piston slidably disposed within the first cylinder for fixing the striking pin and driving the striking pin to move, and a second piston slidably disposed within the second cylinder which is to be driven by the first driving source to do a reciprocating motion.

4. The power tool of claim 1, wherein the locking element has a first position and a second position wherein, when the locking element is in the first position, the locking element engages with the striking pin so as to lock the striking pin and, when the locking element is in the second position, the locking element disengages with the striking pin so as to release the striking pin.

5. The power tool of claim 1, wherein the locking element engages with the striking pin so as to lock the striking pin and the second driving source drives the locking pin to release the striking pin.

6. The power tool of claim 1, further comprising a controller for controlling the second driving source to drive the locking pin so as to release the striking pin wherein the controller is electrically connected with the second driving source.

7. The power tool of claim 6, further comprising a battery pack wherein the controller is electrically connected with the second driving source and the battery pack.

8. The power tool of claim 1, further comprising a biasing element for biasing the locking element to lock the striking pin.

9. The power tool of claim 1, further comprising a battery pack which provides electricity to the first driving source and the second driving source.

10. The power tool of claim 1, further comprising a magazine for storing the fasteners.
